(19) United States
(12) Patent Application Publication
(10) Pub. No.: US 2020/0356195 A1
(43) Pub. Date: Nov. 12, 2020

(54) TOUCH PANEL AND THE MANUFACTURING METHOD THEREOF

(71) Applicant: Wuhan China Star Optoelectronics Technology Co., Ltd., Wuhan, Hubei (CN)

(72) Inventor: Yuejun TANG, Wuhan, Hubei (CN)

(21) Appl. No.: 16/077,433

(22) PCT Filed: Apr. 24, 2018
(86) PCT No.: PCT/CN2018/084147

§ 371 Date: Aug. 10, 2018

(30) Foreign Application Priority Data
Mar. 29, 2018 (CN) 201810271612.2

(51) Int. Cl. G06F 3/041

(52) U.S. Cl. CPC G06F 3/041; G06F 2203/04103; G06F 2203/04102

(57) ABSTRACT

The present disclosure relates to a touch panel and the manufacturing method thereof. The manufacturing method includes: S1: providing a flexible substrate having a first area and a second area adjacent to the first area; S2: forming an electrode layer on the flexible substrate, wherein the electrode layer comprising a first electrode layer on the first area and a second electrode layer on the second area; and S3: applying a first process to the flexible substrate to configure the first area to be symmetrical to the second area along a top-down direction and to arrange the first electrode layer and the second electrode layer in an alternated manner. The first electrode layer and the second electrode layer are made by the same manufacturing process and the same materials, which simplifies the manufacturing process of the touch panel.

### BACKGROUND OF THE INVENTION

### 1. Field of the Invention

The present disclosure relates to the field of touch technology and, in particular, to the field of a touch panel and the manufacturing method thereof.

### 2. The Related Arts

A touch panel (TP, Touch Panel) is a device that is formed on the display surface of an image display device and uses a conductor, such as a human body or a capacitor pen, for command input. Generally, the TP can replace a mechanical input, such as a mouse or a keyboard. Buttons and other input devices can effectively simplify the structure of electronic products, such as computers and mobile phones, and have very broad application prospects.

FIGS. 1 and 2 are schematic views of a conventional touch panel, which includes a first substrate 11′, a second substrate 12′, a first electrode layer 21′ and a second electrode layer 22′ between the first substrate 11′ and the second substrate 12′, and an insulation layer 30′ between the first electrode layer 21′ and the second electrode layer 22′. One of the first electrode layer 21′ and the second electrode layer 22′ is a driving electrode, and the other one is a sensing electrode. The first electrode layer 21′ and the second electrode layer 22′ electrically connect to a bonding end 40′. In the process of manufacturing the first electrode layer 21′ and the second electrode layer 22′, an electrode layer needs to be firstly formed on the first substrate 11′, and then a patterning process is performed to form a first electrode and a patterning process is performed to form a first electrode layer 21.′ Then, an insulating layer is prepared on the first electrode layer 21′. The second electrode layer 22′ is then formed on the insulating layer in the same manner, thereby forming the patterned first substrate 11′ and the patterned second substrate 12′. The manufacturing process is complicated.

Thus, it is necessary to provide a touch panel and the manufacturing method thereof.

### SUMMARY OF THE INVENTION

The present disclosure relates to a touch panel and the manufacturing method thereof to simplify the manufacturing process of the touch panel.

In one aspect, a manufacturing method of touch panels includes: S1: providing a flexible substrate having a first area and a second area adjacent to the first area; S2: forming an electrode layer on the flexible substrate, wherein the electrode layer comprising a first electrode layer on the first area and a second electrode layer on the second area; S3: applying a first process to the flexible substrate to configure the first area to be symmetrical to the second area along a top-down direction and to arrange the first electrode layer and the second electrode layer in an alternated manner.

Wherein the first process in step S3 further includes: bending the flexible substrate along an aligned line of the first area and the second area and inwardly along a direction facing toward the first electrode layer and the second electrode layer

Wherein the first process in step S3 further includes: bending the flexible substrate along the aligned line of the first area and the second area and outwardly along a direction facing away the first electrode layer and the second electrode layer.

Wherein the first process in step S3 further includes: cutting the flexible substrate to separate the first area and the second area, and bonding the flexible substrate after the flexible substrate is cut.

Wherein the bonding step further includes: bonding the first electrode layer and the second electrode layer by moving the first electrode layer and the electrode layer to be closer to each other.

Wherein the bonding step further includes: bonding the first electrode layer and the second electrode layer by moving the first electrode layer and the electrode layer to face away from each other.

Wherein, after the step S2, the method further includes: forming an adhesive layer on the first electrode layer and/or the second electrode layer; and/or forming an insulation layer on the first electrode layer and/or the second electrode layer.

Wherein after the step S2, the method further includes: forming an adhesive layer on a backside of the first electrode layer and/or the second electrode layer and/or forming an insulation layer on a backside of the first electrode layer and/or the second electrode layer.

Wherein the bonding end is configured on an external side of the first area and the second area, and the first electrode layer and the second electrode layer electrically connect to the bonding end, directly or indirectly.

In another aspect, a touch panel manufactured by the manufacturing method as described above.

In view of the above, the first electrode layer and the second electrode layer are made by the same manufacturing process and the same materials, which simplifies the manufacturing process of the touch panel. In addition, the substrate outside the electrode layer may protect the electrode layer from being damaged during being transferred or being adhered.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic view of one conventional touch panel.

FIG. 2 is a cross-section view of one conventional touch panel.

FIG. 3 is a flowchart illustrating the manufacturing method of the touch panel in accordance with one embodiment of the present disclosure.

FIG. 4 is a plan view showing the structure of the touch panel before being bent in accordance with a first, a second, and a third embodiment of the present disclosure.

FIG. 5 is a plan view of the touch panel before being bent in accordance with a fourth embodiment of the present disclosure.

FIG. 6 is a plan view of the touch panel before being bent in accordance with a fifth embodiment of the present disclosure.

FIG. 7 is a plan view of the touch panel before being bent in accordance with a sixth embodiment of the present disclosure.

FIG. 8 is a cross-section view of the touch panel in accordance with the first embodiment of the present disclosure.

FIG. 9 is a cross-section view of the touch panel in accordance with the second embodiment of the present disclosure.

FIG. 10 is a cross-section view of the touch panel in accordance with the third embodiment of the present disclosure.

FIG. 11 is a cross-section view of the touch panel in accordance with the sixth embodiment of the present disclosure.

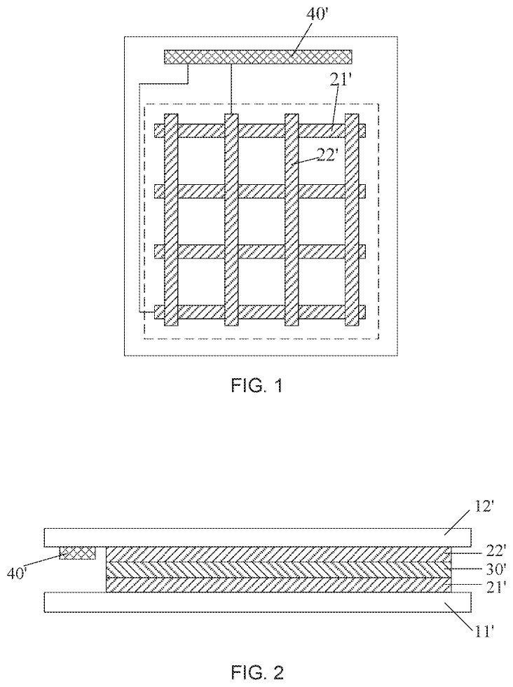

### DETAILED DESCRIPTION OF THE PREFERRED EMBODIMENTS

To further explain the technical means and effect of the present invention, the following refers to embodiments and drawings for detailed description. Apparently, the described embodiments are merely some embodiments of the present invention, instead of all embodiments. All other embodiments based on embodiments in the present invention and obtained by those skilled in the art without departing from the creative work of the present invention are within the scope of the present invention.

As used herein, terms such as “upper”, “above”, “below”, “below”, and the like that indicate spatial relative positions are for the purpose of convenience of description to describe one unit or feature relative to one another as shown in the drawings. The spatially relative terms may be intended to include different orientations of the device in use or operation in addition to the orientation depicted in the figures. For example, if the device in the figures is turned over, elements described as being “below” or “beneath” other elements or features would then be “above” the other elements or features. Thus, the exemplary term “below” can encompass both orientations above and below. The device may be otherwise oriented (rotated 90 degrees or at other orientations) and the spatially relative descriptors used herein interpreted accordingly.

The terms “comprising” and “having” and any variations thereof appearing in the specification, claims, and drawings of the present application are intended to cover non-exclusive inclusion. For example, a process, method, system, product, or device that includes a series of steps or units is not limited to the listed steps or units, but optionally also includes steps or units not listed, or alternatively, other steps or units inherent to these processes, methods, products or equipment. In addition, the terms “first”, “second” and “third” are used to distinguish different objects and not intended to describe a particular order.

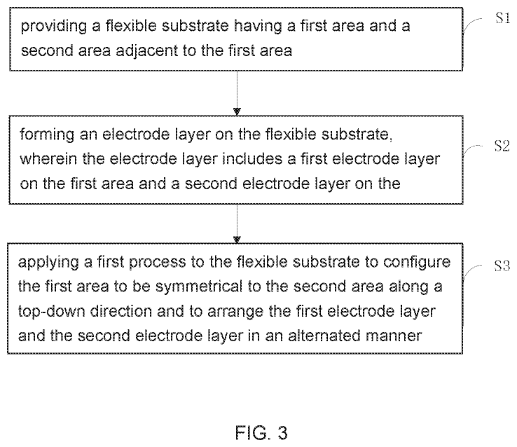

FIG. 3 is a flowchart illustrating the manufacturing method of the touch panel in accordance with one embodiment of the present disclosure.

In step S1, providing a flexible substrate having a first area and a second area adjacent to the first area.

In step S2, forming an electrode layer on the flexible substrate, wherein the electrode layer includes a first electrode layer on the first area and a second electrode layer on the second area.

In step S3, applying a first process to the flexible substrate to configure the first area to be symmetrical to the second area along a top-down direction and to arrange the first electrode layer and the second electrode layer in an alternated manner;

The substrate in the present embodiment is a flexible substrate, and the flexible substrate may be formed by selecting the material from polyimide (PI), polycarbonate (PC), polyether sulfone (PES), polyethylene terephthalate (PET), polyethylene naphthalate (PEN), polyarylate (PAR) or glass fiber reinforced plastic (FRP).

In step S3, the first process includes: bending the flexible substrate along an aligned line of the first area and the second area and inwardly along a direction facing toward the first electrode layer and the second electrode layer; or

bending the flexible substrate along the aligned line of the first area and the second area and outwardly along a direction facing away the first electrode layer and the second electrode layer.

In addition, a bonding end is configured on the flexible substrate, and the bonding end is configured on an external side of the first area and the second area. The first electrode layer and the second electrode layer electrically connect to the bonding end, directly or indirectly.

In one embodiment, the flexible substrate is a cleavable substrate. The flexible substrate may be, in addition to the above-mentioned substrate made of a polymer material, a thin glass substrate, a metal substrate, or the like.

In an example, the first process may include: cutting the flexible substrate to separate the first area and the second area, and bonding the flexible substrate after the flexible substrate is cut.

Specifically, the first electrode layer and the second electrode layer are bonded by moving the first electrode layer and the electrode layer to be closer to each other.

In another direction, the first electrode layer and the second electrode layer may be bonded by moving the first electrode layer and the electrode layer to face away from each other.

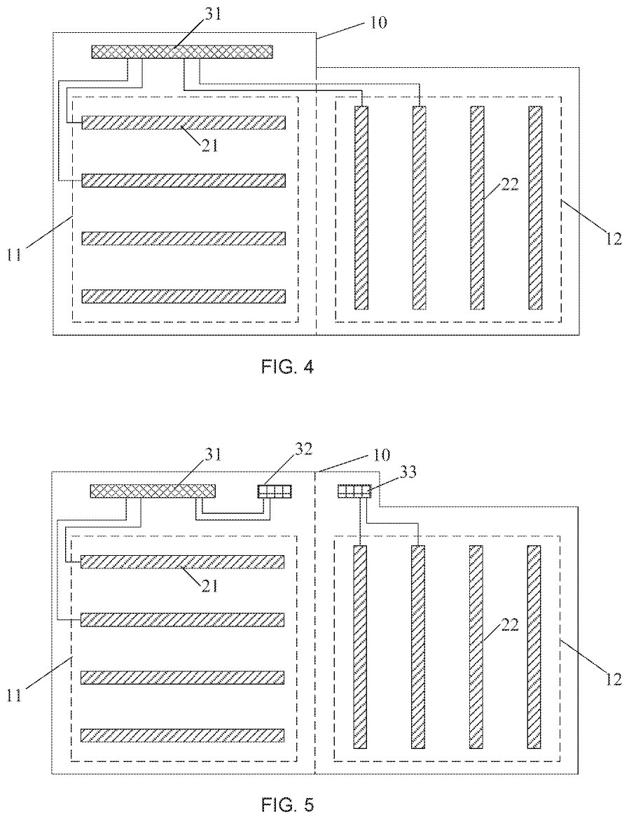

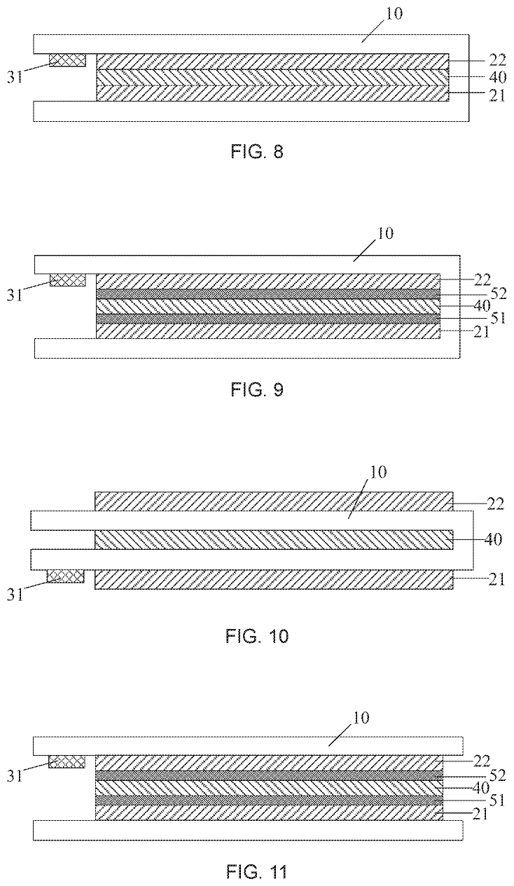

In a first embodiment, referring to FIGS. 4 and 8, the manufacturing method of the touch panel includes: providing a flexible substrate 10 having a first area 11 and a second area 12 symmetrical to each other. A length, a width, and a dimension of the first area 11 is the same with those of the second area 12. A cutting area is configured on a top of the right half of the flexible substrate, and a bonding end 31 is configured on a top of the left half of the flexible substrate.

The flexible substrate may be formed by selecting the material from polyimide (PI), polycarbonate (PC), polyether sulfone (PES), polyethylene terephthalate (PET), polyethylene naphthalate (PEN), polyarylate (PAR) or glass fiber reinforced plastic (FRP).

An electrode layer may be formed on the flexible substrate 10. The electrode layer may be a front electrode formed by deposition.

The flexible substrate 10 is then applied with a patterned process, such as wet etching, to respectively form the first electrode layer 21 and the second electrode layer 22. The first electrode layer 21 and the second electrode layer 22 extend along different directions. In one embodiment, the first electrode layer 21 extends along a first direction, and the second electrode layer 22 extends along a second direction. The first direction is perpendicular to the second direction.

An adhesive layer 40 is formed on the first electrode layer 21 and/or the second electrode layer 22. The adhesive layer 40 is made by insulation material. In an example, the adhesive layer 40 is only formed on the first electrode layer 21 or the second electrode layer 22.

In the end, the flexible substrate 10 is bent along an aligned line of the first area 11 and the second area 12 inwardly toward the first electrode layer 21 and the second electrode layer 22 such that the first electrode layer 21 is perpendicular to the second electrode layer 22. The first area 11 and the second area 12 are touched area. In this way, the touch panel in FIG. 8 is formed.

In an example, each of electrodes on the first electrode layer 21 and the second electrode layer 22 electrically connect to pins of the bonding end 31.

After being inwardly bent, the electrode layer is arranged between the two flexible substrate such that the touch layer is protected by the flexible substrate. Such configuration may prevent the electrode layer from being damaged when being transferred or being adhered.

### Second Embodiment

Referring to FIGS. 4 and 9, the difference between the manufacturing method in this embodiment and that in the first embodiment only resides in that: after the patterned process is applied to form the first electrode layer 21 and the second electrode layer 22, an insulation layer including a first insulation layer 51 and a second insulation layer 52 is formed on the first electrode layer 21 and the second electrode layer 22. Afterward, the adhesive layer 40 is formed on the first insulation layer 51 and the second insulation layer 52. In the end, the flexible substrate is inwardly bent along the aligned line of the first area 11 and the second area 12 toward the first electrode layer 21 and the second electrode layer 22 to form the touch panel in FIG. 9.

It can be understood that the insulation layer may be formed only on the first electrode layer 21 or the second electrode layer 22.

### Third Embodiment

Referring to FIGS. 4 and 10, the difference between the manufacturing method in this embodiment and that in the first embodiment only resides in that: the flexible substrate is outwardly bent along the aligned line of the first area 11 and the second area 12. That is, the flexible substrate 10 is bent along a direction facing away the first electrode layer 21 and the second electrode layer 22 to form the touch panel in FIG. 10.

### Fourth Embodiment

Referring to FIGS. 5 and 8, the flexible substrate 10 includes the first area 11 and the second area 12 symmetrical to the first area 11. A cutting area is configured on a top of the right half of the flexible substrate, and a bonding area is configured on a top of the left half of the flexible substrate. The bonding area is configured to arrange the bonding end 31 and a first connection end 32. A connection area is further configured on the top of the right half of the flexible substrate to arrange a second connection end 33.

In this embodiment, the manufacturing method is the same with that in the first embodiment.

In the embodiment, each of the electrodes of the first electrode layer 21 respectively connect to the pins on the bonding end, and each of the electrodes of the second electrode layer 22 respectively connects to the pins of the second connection end 33. After the flexible substrate is bent, the first connection end 32 and the second connection end 33 are connected to each of the pins in a one-to-one manner through anisotropic conductive adhesive. In addition, the pins of the connection end 32 respectively corresponds to the pins of the bonding end 31. As such, each of the electrodes of the first electrode layer 21 electrically connects to the bonding end 31 directly, and each of the electrodes of the second electrode layer 22 electrically connects to the bonding end 31 via the second connection end 33 and the connection end 32 indirectly.

It can be understood that the insulation layer may be formed on the first electrode layer 21 and the second electrode layer 22 to form the touch panel in FIG. 9. Alternatively, after the flexible substrate is outwardly bent as described in the third embodiment, the touch panel in FIG. 10 may be formed.

### Fifth Embodiment

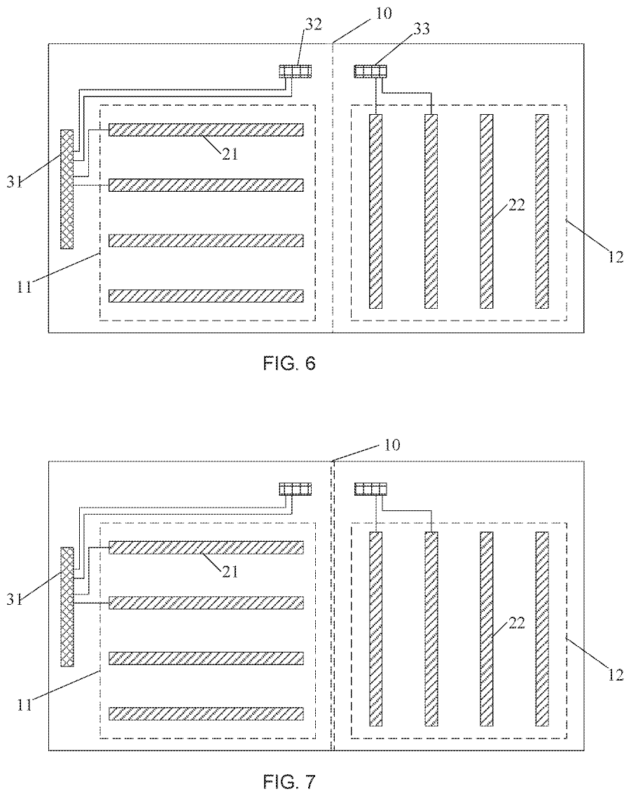

Referring to FIGS. 6 and 9, the flexible substrate 10 includes the first area 11 and the second area 12 symmetrically to the first area 11. The flexible substrate 10 is rectangular-shaped. A bonding end 31 is configured on a top of the left half of the flexible substrate. A connection area is further configured on the top of the right half of the flexible substrate to arrange the connection end 32 and the second connection end 33.

In this embodiment, the manufacturing method is the same with that in the first embodiment.

In the embodiment, each of the electrodes of the first electrode layer 21 respectively connect to the pins on the bonding end, and each of the electrodes of the second electrode layer 22 respectively connects to the pins of the second connection end 33. After the flexible substrate is bent, the first connection end 32 and the second connection end 33 are connected to each of the pins in a one-to-one manner through anisotropic conductive adhesive. In addition, the pins of the connection end 32 respectively corresponds to the pins of the bonding end 31. As such, each of the electrodes of the first electrode layer 21 electrically connects to the bonding end 31 directly, and each of the electrodes of the second electrode layer 22 electrically connects to the bonding end 31 via the second connection end 33 and the connection end 32 indirectly.

It can be understood that the insulation layer may be formed on the first electrode layer 21 and the second electrode layer 22 to form the touch panel in FIG. 9. Alternatively, after the flexible substrate is outwardly bent as described in the third embodiment, the touch panel in FIG. 10 may be formed.

### Sixth Embodiment

Referring to FIGS. 7 and 11, the manufacturing method of the touch panel includes: providing a flexible substrate 10 having a first area 11 and a second area 12 symmetrical to each other. A length, a width, and a dimension of the first area 11 is the same with those of the second area 12. The flexible substrate 10 is rectangular-shaped. A bonding area is configured on a top of the left half of the flexible substrate 10 to arrange the bonding end 31. A connection area is respectively configured on the top of the right half and of the left half of the flexible substrate to arrange the connection end 32 and the second connection end 33.

The substrate in this embodiment is a cleavable substrate, which may be a flexible substrate or a rigid substrate. The flexible substrate may be the substrate mentioned in the above embodiments, and the rigid substrate may be a thin glass substrate or metal substrate, and so on.

An electrode layer may be formed on the flexible substrate 10. The electrode layer may be a front electrode formed by deposition.

The flexible substrate 10 is then applied with a patterned process, such as wet etching, to respectively form the first electrode layer 21 and the second electrode layer 22. The first electrode layer 21 and the second electrode layer 22 extend along different directions. In one embodiment, the first electrode layer 21 extends along a first direction, and the second electrode layer 22 extends along a second direction. The first direction is perpendicular to the second direction.

After the patterned process is applied to form the first electrode layer 21 and the second electrode layer 22, an insulation layer including a first insulation layer 51 and a second insulation layer 52 is formed on the first electrode layer 21 and the second electrode layer 22. Afterward, the adhesive layer 40 is formed on the first insulation layer 51 or the second insulation layer 52.

The flexible substrate 10 is cut to separate the first area 11 and the second area 12. The cut substrate is applied with a bonding process such that the first area 11 and the second area 12 are arranged in a top-down manner. The first electrode layer 21 and the second electrode layer 22 are perpendicular to each other. In an example, the first electrode layer 21 and the second electrode layer 22 are arranged in a middle of the flexible substrate 10. In other embodiments, the first electrode layer 21 and the second electrode layer 22 may be arranged outside the substrate.

In the embodiment, each of the electrodes of the first electrode layer 21 respectively connect to the pins on the bonding end 31, and each of the electrodes of the second electrode layer 22 respectively connects to the pins of the bonding end 31 via the second connection end 33 and the connection end 32 indirectly. The configuration of the bonding end 31, the connection end 32, and the second connection end 33 are the same with that in the fifth embodiment.

In other embodiments, the insulation layer may be formed only on the first electrode layer 21 or the second electrode layer 22.

In view of the above, the first electrode layer 21 and the second electrode layer 22 are made by the same manufacturing process and the same materials, which simplifies the manufacturing process of the touch panel. In addition, the substrate outside the electrode layer may protect the electrode layer from being damaged during being transferred or being adhered.

It should be noted that each of the embodiments in this specification is described in a progressive manner, each of which is primarily described in connection with other embodiments with emphasis on the difference parts, and the same or similar parts may be seen from each other. For the device embodiment, since it is substantially similar to the method embodiment, the description is relatively simple and the relevant description may be described in part of the method embodiment.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A manufacturing method of touch panels, comprising:
S1: providing a flexible substrate having a first area and a second area adjacent to the first area;
S2: forming an electrode layer on the flexible substrate, wherein the electrode layer comprising a first electrode layer on the first area and a second electrode layer on the second area;
S3: applying a first process to the flexible substrate to configure the first area to be symmetrical to the second area along a top-down direction and to arrange the first electrode layer and the second electrode layer in an alternated manner.

2. The manufacturing process as claimed in claim 1, wherein the first process in step S3 further comprises: bending the flexible substrate along an aligned line of the first area and the second area and inwardly along a direction facing toward the first electrode layer and the second electrode layer.

3. The manufacturing process as claimed in claim 1, wherein the first process in step S3 further comprises: bending the flexible substrate along the aligned line of the first area and the second area and outwardly along a direction facing away the first electrode layer and the second electrode layer.

4. The manufacturing process as claimed in claim 1, wherein the first process in step S3 further comprises: cutting the flexible substrate to separate the first area and the second area, and bonding the flexible substrate after the flexible substrate is cut.

5. The manufacturing process as claimed in claim 4, wherein the bonding step further comprises:
bonding the first electrode layer and the second electrode layer by moving the first electrode layer and the electrode layer to be closer to each other.

6. The manufacturing process as claimed in claim 4, wherein the bonding step further comprises:
bonding the first electrode layer and the second electrode layer by moving the first electrode layer and the electrode layer to face away from each other.

7. The manufacturing process as claimed in claim 2, wherein, after the step S2, the method further comprises:
forming an adhesive layer on the first electrode layer and/or the second electrode layer, and/or
forming an insulation layer on the first electrode layer and/or the second electrode layer.

8. The manufacturing process as claimed in claim 5, wherein after the step S2, the method further comprises:
forming an adhesive layer on the first electrode layer and/or the second electrode layer, and/or
forming an insulation layer on the first electrode layer and/or the second electrode layer.

9. The manufacturing process as claimed in claim 3, wherein after the step S2, the method further comprises:
forming an adhesive layer on a backside of the first electrode layer and/or the second electrode layer; and/or
forming an insulation layer on a backside of the first electrode layer and/or the second electrode layer.

10. The manufacturing process as claimed in claim 6, wherein after the step S2, the method further comprises:
forming an adhesive layer on a backside of the first electrode layer and/or the second electrode layer; and/or
forming an insulation layer on a backside of the first electrode layer and/or the second electrode layer.

11. The manufacturing process as claimed in claim 1, wherein the bonding end is configured on an external side of the first area and the second area, and the first electrode layer and the second electrode layer electrically connect to the bonding end, directly or indirectly.

12. A touch panel, wherein the touch panel is manufactured by the manufacturing method as claimed in claim 1.
